(19) United States
(12) Patent Application Publication
(10) Pub. No.: US 2023/0044520 A1
(43) Pub. Date: Feb. 9, 2023

(54) Optimised greenhouse air treatment chamber, and corresponding greenhouse.

(71) Applicant: RICHEL GROUP, EYGALIERES (FR)

(72) Inventors: Christophe Tardy, AIX-EN-PROVENCE (FR); Philippe Sourice, SAINT SYLVAIN D'ANJOU (FR)

(21) Appl. No.: 17/786,979

(22) PCT Filed: Dec. 18, 2020
(86) PCT No.: PCT/EP2020/087336

§ 371 Date: Jun. 17, 2022

(30) Foreign Application Priority Data
Dec. 20, 2019 (FR) FR1915273
Dec. 20, 2019 (FR) FR1915287
Dec. 20, 2019 (FR) FR1915316

(51) Int. Cl. A01G 9/24

(52) U.S. Cl. CPC A01G 9/246; A01G 9/241

(57) ABSTRACT

An air treatment chamber of a cultivation greenhouse. The air treatment chamber includes: at least one inlet for recycling air, delivering air from at least one cultivation zone of the greenhouse; at least one fresh air inlet, delivering air from outside of the greenhouse; and at least one air outlet for feeding the at least one cultivation zone. The fresh air inlet is formed in a lower part of the chamber. An upper part of the chamber, extending above the air inlet, is equipped with elements for passing light to the interior of the greenhouse.

### 1. FIELD OF THE INVENTION

The field of the invention is that of air treatment for cultivation greenhouses. More precisely, the invention relates to devices and other air treatment chambers associated with a cultivation greenhouse, to deliver air in one or more cultivation zones of this greenhouse under optimised temperature and/or humidity conditions.

### 2. PRIOR ART

2.1. First Aspect

227

According to a first aspect of the invention, it is desirable that air inside a cultivation greenhouse is continuously treated, to meet the needs of the crops, particularly with respect to air temperature and/or humidity.

To do so, air treatment means are generally implemented within the greenhouses. These means conventionally comprise one or more air treatment chambers, having at least one inlet for recycling air from a cultivation zone of the greenhouse, and generally placed at an upper part of the chamber, and at least one external air, or fresh air, inlet taking in air from outside the greenhouse, also placed at an upper part of the chamber.

At least one air outlet is provided, delivering the chamber-treated air to the cultivation zone. This air outlet is located at a lower part of the chamber, at the ground level. It is generally equipped with a fan, which directs air into a ventilation pipe having a perforated peripheral wall, extending in proximity to the ground of the cultivation zone.

Depending on the requirements, air inlets can be completely or partly sealed or released by means of sealing flaps.

The air treatment means inside the chamber generally comprise means for cooling the fresh external air, extending in front of the fresh air inlets, which ensure, depending on the case, cooling and/or dehumidification functions, and heating means, for example an air heater, which ensures air heating and air circulation.

Such a chamber may in particular operate in three main modes, namely:
A recycling mode, in which the inlet(s) for recycling air from the cultivation zone are open, while the fresh air inlet(s) are closed, air from the cultivation zone being thus recycled, and its temperature adapted, before being re-injected into the cultivation zone;
An air renewal mode, in which the inlet (s) recycling air is (are) closed while the fresh air inlet(s) is (are) open, so that fresh air from outside the greenhouse is introduced into the cultivation zone, where appropriate after it has been dehumidified, cooled and/or heated;
A mixing mode, in which the inlet(s) for recycling air and the fresh air inlet(s) are open, where appropriate, partially, so that air reinjected into the cultivation zone is formed by a mixture of recycled air and fresh air.

In the different cases, heating, cooling and/or dehumidification means can be implemented, to adapt characteristics of the air reintroduced into the cultivation zone, so that this air is conducive to crop development.

These means are generally placed in the vicinity of the air inlets, at the upper part of the chamber. This approach has a number of drawbacks. First of all, it disturbs arrival of light inside the greenhouse, since the chamber extends along a wall of the greenhouse, depending on the case, on the internal or external side of this wall. But, the cooling means are by nature opaque, that is they do not let light pass. This aspect is important for the efficiency of the crops, since it is known that 1% more external light allows 1% more crop yield, on average.

In addition, maintenance of the equipment is often difficult due to the location thereof. Furthermore, the yield of such a chamber is often insufficient, as air may suffer a drop in temperature before reaching the air outlet.

Finally, implementing and/or controlling means for sealing the various air inlets can often be relatively complex, and not easy to install and/or maintain.

One purpose of the invention, according to these various aspects, is to provide solutions to at least some of these drawbacks.

2.2. Second Aspect

According to a second aspect of the invention, air in a cultivation greenhouse has to be permanently treated so as to meet the needs of the crops.

To do so, air treatment devices are implemented within the greenhouses.

The air treatment devices typically comprise a chamber with at least one inlet for recycling air from the cultivation zone of the greenhouse, at least one inlet for fresh air from outside the greenhouse and at least one air outlet opening into at least one ventilation pipe having a perforated peripheral wall extending to the bottom of the cultivation zone.

The recycling air inlet(s) and the fresh air inlet(s) may be completely or partly sealed or open by means of one or more sealing flaps.

Means may be implemented to heat or cool air in the treatment chamber.

Such a chamber is likely to operate in three main ventilation modes, namely:
a recycling mode in which the inlet(s) for recycling air from the cultivation zone is/are open while the fresh air inlet(s) is/are closed, so that air from the cultivation zone is recycled therein by passing through the treatment chamber;
a renewal mode in which the inlet(s) for recycling air from the cultivation zone is (are) closed while the fresh air inlet(s) is (are) open, so that fresh air from outside the greenhouse is introduced into the cultivation zone by passing through the treatment chamber; the excess air being discharged via overpressure vents generally located on the roof;
a mixing mode in which the inlet(s) for recycling air from the cultivation zone is (are) open in the same way as the fresh air inlet(s) is (are) open, so that fresh air from outside the greenhouse is mixed in the treatment chamber with recycling air from the cultivation zone, this mixture being introduced into the cultivation zone.

The implementation of these three ventilation modes, combined, where appropriate, with the use of heating and/or cooling means, makes it possible to generate a climate in the cultivation zone, the temperature and hygrometry of which are conducive to crop development.

It is known to provide such a treatment chamber in the form of a single climatic chamber disposed either inwardly or outwardly of a greenhouse. The implementation of such a chamber thereby makes it possible to uniformly treat air in the chamber and then introduce it into the greenhouse regardless of the location.

Such an approach is not entirely satisfactory in that it allows air to be treated for the entire greenhouse regardless of the local plant growth conditions or times of the day. However, the EAST wall of the greenhouse is warmer than the WEST wall in the morning, for example, and should be cooled more. The atmosphere created in the greenhouse is therefore not optimal for meeting the needs of the crops.

According to another approach, it is known to provide the treatment chamber in the form of a box, the outlet of which is connected to a ventilation pipe running through the cultivation zone. Several boxes are thus disposed inside or outside the greenhouse.

According to this approach, each box can be regulated differently so that the air treatment can be adapted locally in different zones of the greenhouse to better meet the needs of the crops. However, it is possible to further optimise air treatment in cultivation greenhouses.

In particular, one purpose of the invention is to provide an effective solution to at least some of these different problems.

In particular, according to at least one embodiment, one purpose of the invention is to improve air treatment of a cultivation greenhouse.

In particular, according to at least one embodiment, one purpose of the invention is to provide a box-type air treatment device that is optimised.

Another purpose of the invention, according to at least one embodiment, is to provide such a technique that contributes to improving production yield of a greenhouse.

Another purpose of the invention, according to at least one embodiment, is to provide such a technique that is simple in design and/or efficient and/or reliable and/or robust and/or simple to maintain.

In particular, one purpose of the invention, according to at least one embodiment, is to provide such a technique that is economical.

2.3. Third Aspect

According to a third aspect of the invention, air in a cultivation greenhouse has to be permanently treated so as to meet the needs of the crops.

To do so, air treatment devices are implemented within the greenhouses.

Air treatment devices conventionally comprise a chamber with at least one inlet for recycling air from the cultivation zone of the greenhouse, at least one fresh air inlet from outside the greenhouse, and at least one air outlet opening into at least one ventilation pipe having a perforated peripheral wall extending to the bottom of the cultivation zone.

The inlet(s) for recycling air and the fresh air inlet(s) may be completely or partly sealed or released by means of one or more sealing flaps.

Means may be implemented to heat or cool air in the treatment chamber.

Such a chamber is likely to operate in three main ventilation modes, namely:
a recycling mode in which the inlet(s) for recycling air from the cultivation zone is/are open while the fresh air inlet(s) is/are closed, so that air from the cultivation zone is recycled therein by passing through the treatment chamber;
a renewal mode in which the inlet(s) for recycling air from the cultivation zone are closed while the fresh air inlet(s) are open, so that fresh air from outside the greenhouse is introduced into the cultivation zone by passing through the treatment chamber; the excess air being discharged through overpressure vents generally located on the roof;
a mixing mode in which the inlet(s) for recycling air from the cultivation zone is (are) open in the same way as the fresh air inlet(s) is (are) open, so that fresh air from outside the greenhouse is mixed in the treatment chamber with recycling air from the cultivation zone, this mixture being introduced into the cultivation zone.

The implementation of these three ventilation modes, associated where appropriate with the use of heating and/or cooling means, makes it possible to generate a climate in the cultivation zone the temperature and hygrometry of which are conducive to crop development.

The inlet of each ventilation pipe is provided with a fan to depressurise in the treatment chamber so as to generate air flows thereinside and to convey air contained in the treatment chamber into the corresponding ventilation pipe. The air then diffuses into the treatment zone via perforations provided at the periphery of the pipes.

However, the presence of a fan at the beginning of a pipe induces creation of dynamic pressure and turbulence at the beginning of the pipe. In addition, these phenomena bring about velocity vectors V inside the pipe, which tend to push air blown into the pipes towards the outlet of the pipe (that is towards the end opposite to the one through which the air is blown into the pipe by the fan). Thus, in a zone close to the pipe inlet, air diffuses too inclined through perforations in the pipe, whereas it diffuses much better along the rest of the pipe. This results in a level of air diffusion inside the cultivation zone that is not uniform along the entire length of a pipe. This non-uniform diffusion of air in the cultivation zone results in hotter spots than other spots in the cultivation zone. Thus the climate prevailing inside the cultivation zone is non-homogeneous, which has negative consequences for crop development.

In addition, interconnection of the inlet of a pipe with a fan requires implementation of a rather large connection cone, in that it has to incorporate a flow rectifier to minimise the effects described above.

The implementation of such a connection cone requires a space to be provided between the inlet of the pipe and the chute placed above the sheath, this chute supporting the substrate in which crops grow. It is thus not possible to place crops above the inlet of the pipes, which tends to reduce the cultivable surface area of the cultivation zone, and thus reduce the production yield per ground surface area of a greenhouse.

Sometimes, the implementation of such a connection cone further requires the pipes to be raised by providing a space between them and the ground of the cultivation zone. This makes it more difficult for operators in charge of harvesting to access crops that are placed high enough. Nevertheless, cultivation greenhouse air treatment chambers generally provide fairly effective ventilation of a greenhouse. However, they can be further improved.

In particular, one purpose of the invention is to provide an effective solution to at least some of these different problems.

In particular, according to at least one embodiment, one purpose of the invention is to provide a technique for treating the air of a cultivation greenhouse which makes it possible to generate homogeneous climate inside the cultivation zone of a greenhouse.

In particular, one purpose of the invention, according to at least one embodiment, is to provide such a technique which contributes to increasing cultivable surface area of a greenhouse for a given ground surface area.

Another purpose of the invention, according to at least one embodiment, is to provide such a technique which contributes to facilitating access to the crops by the operators in charge of harvesting.

Another purpose of the invention, according to at least one embodiment, is to provide such a technique that is simple in design and/or efficient and/or reliable and/or robust.

In particular, one purpose of the invention, according to at least one embodiment, is to provide such a technique that is economical.

### 3. DISCLOSURE OF THE INVENTION

3.1 First Aspect of the Invention

Thus, the invention relates to an air treatment chamber of a cultivation greenhouse, comprising at least one inlet for recycling air, delivering air from at least one cultivation zone of said greenhouse, at least one fresh air inlet, delivering air from outside said greenhouse, and at least one air outlet for feeding said at least one cultivation zone.

According to the invention, said fresh air inlet is formed in a lower part of said chamber, and an upper part of said chamber, extending above said air inlet, is equipped with elements for passing light to the interior of said greenhouse.

In this way, the light more efficiently penetrates into the greenhouse, at the cultivation zone, thereby increasing the yield of the crops.

According to one particular aspect of the invention, the chamber may comprise means for sealing said fresh air inlet which may assume at least three positions:
a closed position, in which said fresh air inlet is completely sealed;
at least one first open position, in which an upper part of said fresh air inlet is open, for passing air therethrough; and
at least one second open position, in which a lower part of said fresh air inlet is open, for passing air therethrough.

By allowing the lower part or the upper part to be selectively opened, it is in particular possible to select passage of this fresh air into heating means (via the upper part) or not (via the lower part).

According to one particular aspect, said sealing means can assume at least two first open positions and/or at least two second open positions, so as to modulate amount of air from outside.

According to one particular aspect, said sealing means comprise a flap sliding in parallel to said fresh air inlet, movable so as to be able to assume said closed position and said first and second open positions.

This approach is efficient, as it allows the different opening and closing levels to be simply driven with a single flap.

According to different implementations, said sealing means may be mounted outside said chamber or inside said chamber.

According to one particular embodiment, the chamber comprises air heating means, mounted facing said air inlet so that:
in at least one first open position, fresh air circulates inside said air heating means; and
in at least one second open position, fresh air is not treated by said air heating means. According to one particular aspect, the air treatment chamber may comprise at least one recycling air duct, connecting an upper part of said greenhouse to said inlet for recycling air, the latter being placed in close proximity to the upper part of said fresh air inlet.

In particular, said inlet for recycling air is placed so that said flap seals said inlet for recycling air in at least one of said second open positions.

It is thus possible to manage closing and opening of both air inlets with a single flap. According to another particular aspect, the air treatment chamber may comprise at least two fresh air inlet openings, a first opening being equipped with cooling and/or dehumidification means, and a second opening being placed so that fresh air circulates into heating means.

In this case, said flap may be provided to seal both fresh air inlets or selectively release one of said fresh air inlets.

The invention also relates to cultivation greenhouses comprising at least one cultivation zone and at least one air treatment chamber as described above.

In particular, in such a greenhouse, said treatment chamber may be provided inside said greenhouse between at least one peripheral wall of said greenhouse and an inner partition wall separating said cultivation zone from said air treatment chamber.

Said treatment chamber may also be provided outside said greenhouse between a peripheral wall of said greenhouse and outer partition walls separating said air treatment chamber from outside.

3.2 Second Aspect of the Invention

According to a second aspect, the invention provides a greenhouse air treatment device, said device comprising a box, said box comprising:
at least one inlet for recycling air able to cooperate with a cultivation zone of said greenhouse,
at least one fresh air inlet able to cooperate with the outside of said greenhouse;
an air outlet for being connected to a ventilation pipe having a perforated peripheral wall provided to extend into said cultivation zone;

said box comprising an upper face, a lower face, a bottom for coming in proximity to a wall of a cultivation greenhouse and two lateral sides and being closed by at least one planar heat exchanger (preferably a water evaporation cooling means or the like) extending opposite to said bottom not in parallel thereto, said fresh air inlet being at least partly consisting of said at least one heat exchanger.

Thus, the invention is based on an original approach which consists in closing an air treatment box by means of at least one heat exchanger through which fresh air enters the box, this heat exchanger not being parallel to the bottom of the box for coming in proximity to a wall of a greenhouse, but instead being tilted.

If the box were closed by means of a single heat exchanger parallel to the bottom, its surface area would be identical to that of the bottom. By using an inclined heat exchanger, the surface area of the heat exchanger is greater than the surface area of the bottom.

The invention thus makes it possible to significantly increase exchange surface area of the fresh air with the heat exchange means in a reduced remaining overall space.

The invention thus makes it possible to optimise heat exchanges with fresh air while maintaining a good level of compactness.

Better still, the invention makes it possible to reduce height of the box while offering an equivalent or even greater exchange surface area.

Reducing the height of the box makes it possible to increase amount of light entering the greenhouse when the box is joined thereto. Indeed since the box is opaque, the lower the height of the box, the more light it allows into the greenhouse.

Given that 1% more light in the greenhouse induces a 1% increase in the production yield in the greenhouse, the implementation of the invention contributes to improving yield of the greenhouse.

According to one possible characteristic, said box is enclosed by two planar heat exchangers or by a planar heat exchanger and a planar insect net, said two exchangers or said exchanger and said net forming an angle.

According to one possible characteristic, the value of said angle is between 25 and 70°.

According to one possible characteristic, at least one of said exchangers constitutes an access door to the interior of said box.

According to one possible characteristic, said box comprises an inner partition wall delimiting inside said box a fresh air intake zone into which said fresh air inlet opens and a mixing zone into which said inlet for recycling air opens, said inner partition wall having at least one opening passing therethrough, fluidly communicating said intake and mixing zones.

According to one possible characteristic, a device according to the invention comprises a flap for sealing said opening.

According to one possible characteristic, a device according to the invention comprises a flap for sealing said inlet for recycling air.

According to one possible characteristic, said flap(s) are of the sliding or pivoting type, said flap(s) being of the same or different type.

According to one possible characteristic, a device according to the invention comprises a fan, said fan being positioned in said air outlet.

According to one possible characteristic, a device according to the invention comprises a fan, said fan being positioned in said mixing zone upstream of said air outlet.

According to one possible characteristic, each heat exchanger is connected to a heat transfer fluid feed flexible pipe and a heat transfer fluid discharge pipe, the connection of the heat exchangers to their respective pipes being made in proximity to the link of the heat exchanger with said box. The invention also relates to a cultivation greenhouse comprising a cultivation zone and at least one device according to any of the aforementioned alternatives, said inlet for recycling air and said air outlet of said box being connected to said cultivation zone of said greenhouse. According to one possible characteristic, a greenhouse according to the invention comprises a plurality of air treatment devices juxtaposed along a peripheral wall of said greenhouse. According to one possible characteristic, at least some of the air treatment devices are differently regulated so as to allow creation of different atmospheres in different ventilation pipes of said greenhouse.

3.3 Third Aspect of the Invention

According to a third aspect, the invention provides a cultivation greenhouse air treatment chamber, said chamber comprising:
at least one inlet for recycling air able to cooperate with a cultivation zone of said greenhouse, and at least one fresh air inlet able to cooperate with the outside of said greenhouse;
at least one air outlet for being connected to at least one ventilation pipe having a perforated peripheral wall provided to extend into said cultivation zone; and
at least one fan configured to pressurise at least one zone of said chamber and to induce passage of air contained in said pressurised zone to said at least one air outlet towards said at least one pipe.

Thus, the invention is based on an original approach which consists in providing an air treatment chamber provided with at least one fan able to pressurise at least one zone of the chamber and to induce passage of the air contained in the pressurised zone towards an air outlet opening into a ventilation pipe placed in a cultivation zone of a greenhouse.

The pressurised zone constitutes a plenum.

Such a plenum constitutes a calming zone allowing air contained in the chamber to enter the ventilation pipes under the effect of a predominantly static pressure. This makes the penetration of air into a pipe more linear and less turbulent. As a result, the air diffuses through the peripheral perforations of the pipe in an essentially homogeneous manner along the entire pipe, from the inlet of the pipe. Indeed, the velocity vectors of air jets through these perforations are almost perpendicular to the axis of the pipe along the same.

The homogeneous diffusion of the air all along the length of the pipes avoids hot or cold spots in the cultivation zone and creates a homogeneous climate therein.

This is conducive to crop development and increased production yield.

In addition, a pipe is no longer directly interconnected with a fan. Thus, it is not necessary to use a bulky connection cone between the pipe and the fan.

This allows the pipes to be disposed lower to the ground, thus lowering the gutters above the pipes containing the substrate in which crops grow. The crops, which are set lower, are thus more easily accessible to the operators working on their maintenance and harvesting.

This also makes it possible to dispose gutters closer to the inlet of the pipes and thus to increase the cultivable surface area of the cultivation zone, for a given ground surface area of the greenhouse. This increases the yield of the greenhouse for a given ground surface area.

According to one possible characteristic, a chamber according to the invention comprises:
an upper zone comprising at least one inlet for recycling air able to cooperate with a cultivation zone of said greenhouse, and at least one fresh air inlet able to cooperate with the outside of said greenhouse;
a lower zone comprising at least one air outlet for being connected to at least one ventilation pipe having a perforated peripheral wall provided to extend into said cultivation zone; at least one air passage being provided between said upper zone and said lower zone, said chamber comprising at least one fan disposed between said upper and lower zones, said fan being configured to induce passage of air contained in said upper zone into said lower zone.

According to one possible characteristic, said fan comprises a rotor the axis of rotation of which extends substantially vertically.

According to one possible characteristic, the number of fans is not equal to the number of air outlets.

According to one possible characteristic, a chamber according to the invention comprises at least one flap for sealing said inlet for recycling air.

According to one possible characteristic, a chamber according to the invention comprises or at least one flap for sealing said fresh air inlet.

According to one possible characteristic, said flaps for sealing said inlet for recycling air and said fresh air inlet are of the swinging type or of the sliding type, said flaps for sealing said inlet for recycling air and said fresh air inlet being of the same or different types.

According to one possible characteristic, a chamber according to the invention comprises recycling air heating means housed in said upper zone.

According to one possible characteristic, a chamber according to the invention comprises fresh air cooling means housed in said lower or upper zone.

The invention also relates to a cultivation greenhouse comprising a cultivation zone and an air treatment chamber according to any of the alternatives set out hereinabove.

According to one possible characteristic, said treatment chamber is provided inside said greenhouse between at least one peripheral wall of said greenhouse and an inner partition wall separating said cultivation zone from said air treatment chamber.

According to one possible characteristic, said treatment chamber is provided outside said greenhouse between a peripheral wall of said greenhouse and outer partition walls separating said air treatment chamber from outside.

### 4. DESCRIPTION OF THE FIGURES

Other purposes, characteristics and advantages of the invention will become clearer upon reading the following description, given by way of simple illustrative, and in no way limiting, example in connection with the figures, among which:

FIG. 1 is a view of an example of an air treatment chamber according to the invention, implemented in a lean-to corridor mounted outside the structure of a greenhouse;

FIG. 2A illustrates a first embodiment of the invention, the air treatment chamber being in an air recycling position;

FIG. 2B sets forth the chamber of FIG. 2A in an air dehumidification position;

FIG. 2C shows the chamber of FIGS. 2A and 2B, in an air cooling position;

FIG. 3A illustrates a second embodiment of the invention, the air treatment chamber being in an air recycling position (flap closed);

FIG. 3B sets forth the chamber of FIG. 3A in an air dehumidification position;

FIG. 3C illustrates the chamber of FIGS. 3A and 3B in a first fresh, or external, air and recycling air mixing position;

FIG. 3D illustrates the chamber of FIGS. 3A to 3C in a second fresh, or external, air and recycling air mixing position;

FIG. 4A illustrates a third embodiment of the invention, the air treatment chamber being in an air recycling position (flap closed);

FIG. 4B sets forth the chamber of FIG. 4A in an air dehumidification position;

FIG. 4C illustrates the chamber of FIGS. 4A and 4B, in a second fresh, or external, air and recycling air mixing position;

FIG. 5 illustrates a perspective view of an example of an air treatment device according to the invention;

FIG. 6 illustrates a cross-sectional view of the device of FIG. 1 in a plane perpendicular to the bottom and parallel to the lateral sides and passing through the connection line between both exchangers;

FIG. 7 illustrates an example of a heat exchanger of a device according to the invention;

FIG. 8 illustrates the integration of the device according to the invention along a greenhouse;

FIG. 9 illustrates a cross-sectional view in a plane parallel to the lower face of an alternative of the device according to FIG. 1 comprising a single exchanger;

FIG. 10 schematically illustrates a first example of an air treatment chamber according to the invention;

FIG. 11 schematically illustrates a second example of an air treatment chamber according to the invention;

FIG. 12 illustrates a perspective view of an example of a cultivation greenhouse;

FIG. 13 illustrates the integration of a chamber according to the invention inside a greenhouse;

FIG. 14 illustrates the integration of a chamber according to the invention outside a greenhouse;

FIG. 15 illustrates a perspective view of a greenhouse provided with a chamber according to the invention placed outside the greenhouse like a lean-to, against the long side;

FIG. 16 illustrates a perspective view of a greenhouse with a chamber according to the invention placed outside the greenhouse like a lean-to, along the gable.

### 5. DETAILED DESCRIPTION OF EMBODIMENTS OF THE INVENTION

A—First Aspect

### 5.1 Structure of the Chamber

A first aspect of the invention is set forth in connection with FIGS. 1 to 4C.

As illustrated in the embodiment of FIG. 1, an air treatment chamber according to the invention is placed along a structure wall 11 of a greenhouse. This chamber 12 is in the form of a lean-to corridor mounted outside the greenhouse structure. In one embodiment, of course, the chamber can be mounted inwardly of wall 11.

According to the invention, the opening 13 allowing fresh air, or external air, to enter, conventionally equipped with cooling means 14, also ensuring dehumidification, for example in the form of a radiator, is placed in the bottom part PB of the chamber, so as to release an essentially transparent zone in the top part PH, allowing passage of light 15 through a transparent wall.

Thus, whereas according to prior art it is considered that the fresh air inlet and the associated cooling means have to be placed at the upper part, as well as the heating means to allow, where appropriate, air (fresh and/or recycled) to be heated before it is sucked in by fans ensuring diffusion in the greenhouse, the invention provides a new and efficient approach, consisting in placing the air inlet and the cooling means as close as possible to the ground, which has numerous advantages, and in particular:
Greater passage of light to the cultivation zone;
Easier maintenance;
Temperature optimisation at the outlet of the chamber.

Indeed, this approach makes it possible to mount the air heating means 17, for example an air heater, in the bottom part PB of the chamber, for example, in front of the upper part of the air inlet 13. In this way, the space in the top part PH remains free, and allows passage of light to the cultivation zone. Maintenance of the air heater 17 and of the cooling means 14 is done at man's height, and the distance travelled by the air cooled and/or dehumidified by the cooling means 14 and/or heated by the air heater 17 follows a reduced path in the bottom part PB, which allows the selected temperature at the outlet of the cooling means 14 and/or of the air heater 17 to be weakly modified at the air outlet corresponding to the fan 16, which sends air into the air diffusion pipe 19 in the cultivation zone.

According to the different implementations, and as will be described in more detail later, air diffused in the pipe 19 may come, completely or partly, from inside the greenhouse. This air is then recovered from the upper part of the chamber 12, via an opening 110, which can be open or closed, or assume an intermediate open position, using an adapted sealing means 111, for example, a pivoting hatch.

It is also possible to introduce fresh or external air through the opening 13. Means for sealing this opening 13 are also provided, for example in the form of a vertically sliding flap 114 allowing all or part of the opening 13 to be released. In the embodiment illustrated in FIG. 1, the opening 13 and the flap 114 are mounted in such a way that the flap can be moved in two directions, upwards and downwards, so as to selectively release a lower part or an upper part of the opening 13, which allows the fresh air introduced to pass, in a first configuration, directly into the bottom part of the chamber, or to be treated beforehand by the air heater 17 in a second configuration.

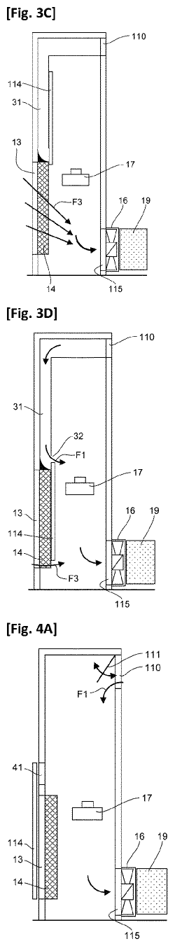

The sealing means can of course be adapted, and in particular two distinct flaps may be provided, one associated with the lower part and the other with the upper part of the opening. Other opening mechanisms than with a sliding movement can be contemplated. The flap(s) may furthermore be mounted outwardly of the chamber (as in FIG. 1) or on the inside of the chamber (embodiments of FIGS. 3A to 3D).

### 5.2 First Embodiment

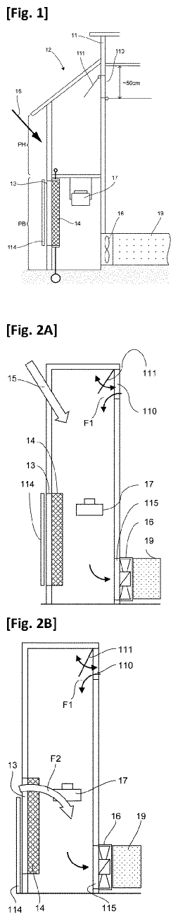

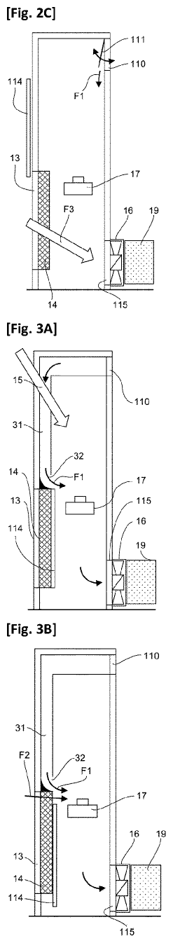

In the embodiment of FIGS. 2A to 2C, the flap 114 can move vertically, in two directions, upwards and downwards. Three main modes of operation can therefore be defined:
FIG. 2A: Recycling mode: the flap 114 completely seals the opening 13, and recycled air (F1), from the upper part of the greenhouse, is introduced into the chamber at the top part, the hatch 111 being open. This recycled air passes through the air heater 17, which ensures air heating and circulation towards the bottom part of the chamber and the air outlet 115 thereof;
FIG. 2B: Dehumidification mode: the flap 114 is moved downwards, releasing an upper part of the opening 13. The fresh air (F2) is cooled and consequently dehumidified by the cooling means 14, then passes through the air heater 17 to be brought to the desired temperature;
FIG. 2C: Cooling mode: the flap 114 is moved upwards, releasing a lower part of the opening 13. The cooled and dehumidified fresh air (F3) enters directly into the bottom part of the chamber, without passing through the heating means 17.

In the different modes, intermediate situations can of course be defined, by opening the hatch 111 to a greater or lesser extent (different positions are illustrated as examples in FIGS. 2A to 2C) and/or the flap 114, so as to modulate amounts of recycled, heated or not, air and fresh air introduced into the greenhouse via the air outlet.

### 5.3 Second Embodiment

FIGS. 3A to 3D illustrate a second embodiment of the invention. In comparison with the first embodiment, the hatch 111 for introducing recycled air gives way to a conduit 31, connecting the opening 110 to a recycled air outlet 32 placed in proximity to the upper part of the fresh air opening 13.

In this embodiment, the flap 111 is placed inside the chamber, along cooling means 14, and mounted so that, depending on its positions, it closes or releases, completely or partially, the recycled air outlet. Thus, a single flap, and therefore simple actuation and control, make it possible to manage opening and closing of all the air inlets, nevertheless with two restrictions:
the inlets for recycling air and fresh air inlets cannot be closed at the same time;
the recycled air and fresh air mixing mode (FIG. 3D) allows only a limited flow rate for both types of air.

Thus, four main modes of operation can be defined:
FIG. 3A: recycling mode: the flap 114 completely seals the opening 13, and recycled air, from the upper part of the greenhouse, is introduced into the chamber via the outlet 32. This recycled air passes through the air heater 17, which ensures air heating and circulation to the bottom part of the chamber and the air outlet thereof;
FIG. 3B: dehumidification mode (mixing with external air intake at the upper part): the flap 114 is moved downwards, releasing an upper part of the opening 13. The fresh air (F2) is cooled and consequently dehumidified by the cooling means 14, then passes through the air heater 17 to be brought to the desired temperature. In this embodiment, recycled air (F1) also enters the chamber, and is mixed with fresh air;
FIG. 3C: cooling mode: the flap 114 is moved upwards, releasing all or part of the opening 13, and sealing the recycled air inlet 32. The cooled and dehumidified fresh air (F3) enters directly into the bottom part of the chamber, without passing through the heating means 17;
FIG. 3D: dehumidification mode (mixing by external air intake at the lower part): the flap 114 is moved upwards, releasing a lower part of the opening 13. The cooled and dehumidified fresh air (F3) enters directly into the bottom part of the chamber, without passing through the heating means 17. In this mode, the opening 32 is partially open and recycled air (F1) also enters the chamber, and is mixed with fresh air.

In the different modes, intermediate situations can of course be defined, depending on the position of the flap, in order to modulate amounts of recycled air and fresh air, heated or not, introduced into the greenhouse via the air outlet.

### 5.4 Third Embodiment

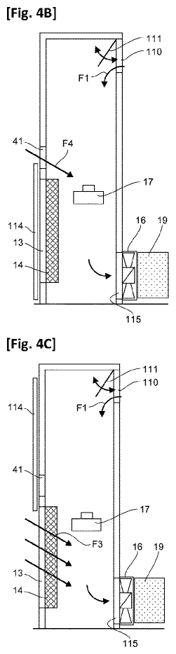

FIGS. 4A to 4D illustrate a third embodiment of the invention. In comparison with the first embodiment, a second fresh air inlet 41 is provided, above the first inlet 13. This second inlet is not associated with cooling means, so that fresh air is directed directly to the heating means (FIG. 4B).

In one alternative, a single opening may be provided, the upper part of which does not face any cooling means.

The flap 114 is adapted to be able to seal both openings 13 and 41 simultaneously.

Three main modes of operation can therefore be defined:
FIG. 4A: recycling mode: the flap 114 completely seals the openings 13 and 41, and recycled air (F1), from the upper part of the greenhouse, is introduced into the chamber in the top part, the hatch 111 being open. This recycled air passes through the air heater 17, which ensures air heating and circulation towards the bottom part of the chamber and the air outlet thereof;
FIG. 2B: dehumidification mode: the flap 114 is moved downwards, releasing an opening 41. The fresh air (F4) passes through the heater 17 to be brought to the desired temperature, without having passed through any cooling and/or dehumidification means beforehand;
FIG. 3C: cooling mode: the flap 114 is moved upwards, releasing a lower part of the opening 13. The cooled and dehumidified fresh air (F3) enters directly into the bottom part of the chamber, without passing through the heating means 17.

In the different modes, intermediate situations can of course be defined, by opening the hatch 111 and/or the flap 114 to a greater or lesser extent, so as to modulate amounts of recycled air and fresh air, heated or not, introduced into the greenhouse via the air outlet.

B—Second Aspect

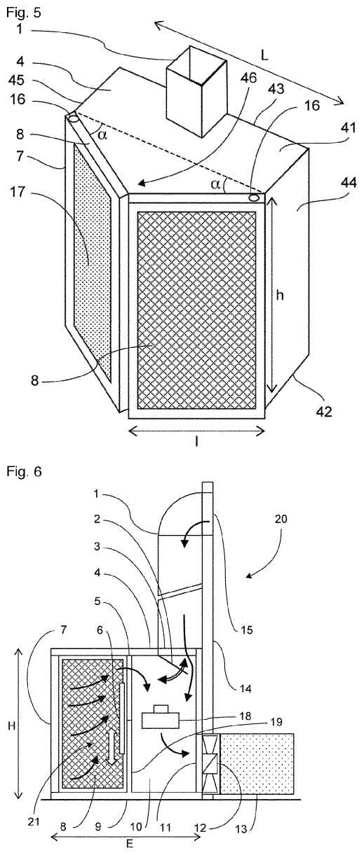

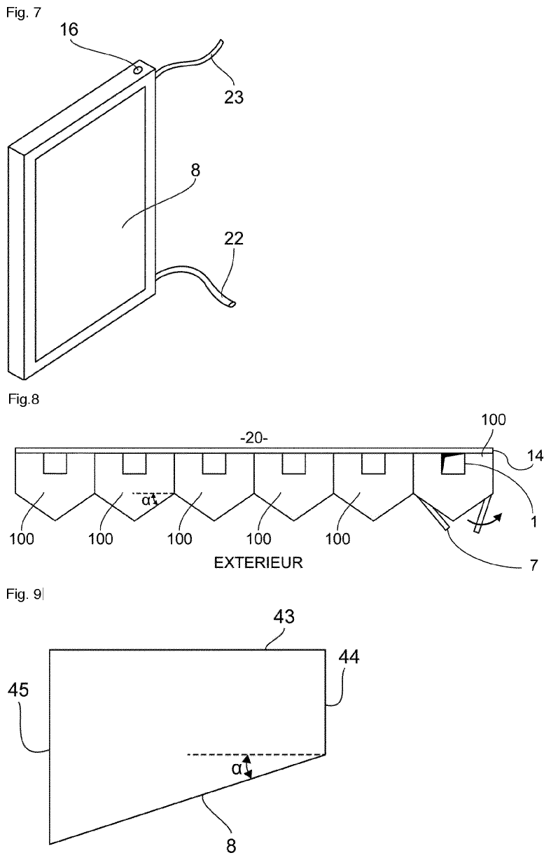

An example of a cultivation greenhouse air treatment device according to a second aspect of the invention is set forth in connection with FIGS. 5 to 9.

As is represented, such a device 100 comprises a box 4.

This box 4 comprises an upper face 41, a lower face 42 for resting on the ground 9, a bottom 43 for coming in proximity to a wall of a cultivation greenhouse and two lateral sides 44, 45. Opposite to the bottom 43, the box comprises an opening 46. This opening preferably extends from the lower face 42 to the upper face 43 and from the side 44 to the side 45. In one alternative, it could have smaller dimensions.

The opening 46 is closed by means of two planar heat exchangers 8, preferably evaporative cooling means. These heat exchangers are not parallel to the bottom 43 and form an angle α. The angle α is the angle formed between the heat exchanger and an axis parallel to the bottom. The value of the angle α is preferably between 25° and 70°.

One or both heat exchangers 8 are covered with an optional insect net 17.

In one alternative, only one heat exchanger may be implemented, the second heat exchanger being replaced with an insect net 17.

In another alternative, only one heat exchanger may be implemented to close the box. In this case, the upper 41 and the lower 42 faces will be trapezoid-shaped. This heat exchanger may or may not be covered with an insect net.

The box further comprises at least one inlet for recycling air 3 able to cooperate with a cultivation zone 20 of a greenhouse. This inlet 3 is preferably provided through the upper face 41. However, it could also be provided through the bottom 43 or through one of the sides 44, 45 although this is less practical.

The box comprises at least one fresh air inlet able to cooperate with the outside of said greenhouse. This inlet consists of the heat exchanger(s) or net 17.

The box comprises an air outlet 11 for being connected to a ventilation pipe 13 having a perforated peripheral wall provided to extend into the cultivation zone 20.

The heat exchanger(s) and/or insect net may be fixedly secured to the box. However, at least one of them, and preferably both where appropriate, constitute(s) a door or doors 7 for access to the interior of the box.

For this, the exchanger, possibly covered with an insect net, or the net is connected to the box, and in particular to the sides 44, 45 by means of hinges 16, pin hinges or the like. Locking means, such as a hook, a lock, a strike-bolt system or the like, could also be implemented to keep the door(s) closed.

The implementation of this door or these doors can allow an operator to enter the box to carry out for example maintenance operations therein.

The box comprises an inner partition wall 19. This inner partition wall extends vertically to delimit inside the box a fresh air intake zone 21 into which the fresh air inlet opens and a mixing zone 10 (also called mixing zone) into which the inlet for recycling air 3 opens. The inner partition wall is preferably removable to facilitate maintenance of the device.

The inner partition wall has at least one opening 5 passing therethrough, fluidly communicating the intake 21 and mixing 10 zones.

The device comprises a flap 6 for sealing the opening 5. It is herein a sliding flap. However, it could be replaced with a pivoting flap.

The device comprises a flap 2 for sealing the inlet for recycling air 3. It is herein a pivoting flap. However, it could be replaced with a sliding flap.

The mixing zone houses heating means 18 which may, for example, comprise an air heater or any other adapted means.

The device comprises a fan 12. This fan is preferably positioned in the air outlet 11. However, the fan could be positioned in the mixing zone upstream of the air outlet for example below the heating means. In this case, it could for example be placed in the opening of a horizontal partition wall which would separate the mixing zone into an upper mixing zone and a lower zone forming a plenum.

Preferably, each heat exchanger is connected to a heat transfer fluid feed flexible pipe 23 and a heat transfer fluid discharge pipe 22, the connection of the heat exchangers to their respective pipes being made in proximity to the link of the heat exchanger with the box.

The height H of the box is preferably between 1.8 and 2.7 metres. Its thickness E could preferably be between C and D metres. Its width L could preferably be between 1.3 and 2 metres.

The height h of the exchangers is preferably between 1.6 and 2.5 metres. Their width I could preferably be between 1 and 1.8 metres.

Motor means for moving the sealing flaps and regulation means are conventionally implemented to control opening/closing of the various flaps and to control implementation of the cooling means (heat exchanger) and the heating means to generate the desired atmosphere. Such regulation means are known per se and are not described in detail herein.

It is possible to move the heat exchangers 8 closer to the fan 12 to increase air cooling in the mixing zone.

One or more treatment devices could be leant against a peripheral wall of a greenhouse (front or gable wall), preferably butt-joined to each other. However, they could be spaced apart from each other.

The inlets for recycling air 3 will be connected to the cultivation zone of the greenhouse by means of conduits 1. The inlet of each of these conduits 1 will be connected to an opening 15 provided through the greenhouse wall 14 against which the box is leaning.

These ducts could extend outside the greenhouse as is represented in FIG. 6. Alternatively they could extend inside the greenhouse and only open outside the greenhouse at the inlet 3.

The different air treatment devices could be regulated identically. Thereby, they will operate identically.

The different air treatment devices could also each operate specifically. Each row of crops (each pipe) will then have a dedicated air treatment device to create a particular atmosphere air. However, at least some of the air treatment devices will be regulated differently, either for location reasons or for functional reasons, for example to allow different atmospheres to be created in different ventilation pipes in the greenhouse and consequently in different parts of the cultivation zone.

For example, a group of two treatment devices could be dedicated to the west wall. For example, one out of five treatment devices could be used for cooling the greenhouse, and four out of five treatment devices would recycle air from the greenhouse to recycle it, each operating without mixing, with mixing taking place in the greenhouse.

Any other combination of operation is possible.

The implementation of the invention provides many advantages, including the following. Because of the optimisation of the exchange surface area of the exchanger(s) by means of their tilt, it is possible to reduce to a minimum the height of the box, which will preferably be at man's height. This allows more light to enter the greenhouse and increases production yield.

The implementation of doors 7 facilitates maintenance.

In addition, maintenance is selective since it is possible to operate on a single air treatment device without affecting operation of the others.

This technique also makes it possible to provide targeted air treatment for each row of crops, i.e. for each pipe or for groups of pipes in order to create zones of different atmospheres in the greenhouse to create different cultivation zones. This allows the treatment zone to be functionalised by dividing it into several portions of different atmospheres to produce different crops in a same greenhouse. This may more simply allow creation of a homogeneous atmosphere/climate in the greenhouse despite the fact that climatic conditions outside the greenhouse are not uniform therearound.

In alternatives, it will be possible to mechanically and functionally gather several treatment devices. For example, the flaps 6 of juxtaposed treatment devices, having concentric motor spindles, could be linked gradually and actuated by a single motor in the case where a group of boxes have a dedicated operation. This principle is applicable to flap 2.

An air treatment device according to the invention is particularly compact. It can also be delivered fully equipped and ready for use by connecting the fluid and electrical connections.

The alternative of creating a plenum in the box has many advantages.

Such a plenum provides a calming zone allowing air contained in the mixing chamber to enter the ventilation pipes under the effect of a predominantly static pressure. This makes the penetration of air into a pipe more linear and less turbulent. As a result, the air diffuses through the peripheral perforations of the pipe essentially homogeneously along the entire pipe, from the inlet of the pipe. Indeed, the velocity vectors of the air jets through these perforations are almost perpendicular to the axis of the pipe along the same.

The homogeneous diffusion of the air along the entire length of the pipes avoids hot or cold spots in the cultivation zone and creates a homogeneous climate therein.

This is conducive to crop development and increased production yield.

In addition, a pipe is no longer directly interconnected to a fan. Thus it is not necessary to implement a bulky connection cone between the pipe and the fan.

This allows the pipes to be disposed lower to the ground, thus lowering the gutters above the pipes containing the substrate in which the crops grow. Crops, which are set lower, are thus more easily accessible to the operators working on their maintenance and harvesting.

This also makes it possible to place gutters closer to the inlet of the pipes and thus to increase the cultivable surface area of the cultivation zone for a given ground surface area of the greenhouse. This increases the yield of the greenhouse for a given ground surface area.

According to one particular embodiment, a treatment device according to the invention comprises a unitary and independently constructed box gathering all the air treatment means necessary for feeding a diffusion tube in a cultivation greenhouse in order to create therein a homogeneous climate conducive to uniform plant growth. At the inlet, this box has a door for access to the machinery and includes a heat exchanger providing the function of cooling air passing therethrough. Its tilted position increases the air treatment surface area, and therefore reduces the height of the box. By design, the boxes can cooperate in sub-groups to control climate of specific zones in the greenhouse. By design, their maintenance from outside is simple and can be done unitarily without shutting down the whole facility.

C—Third Aspect

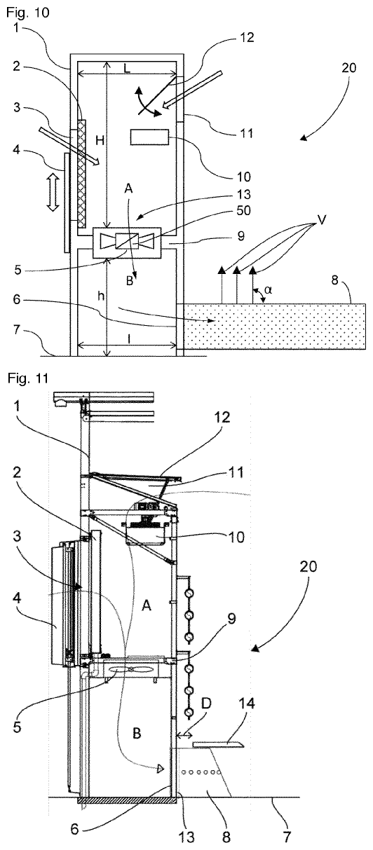

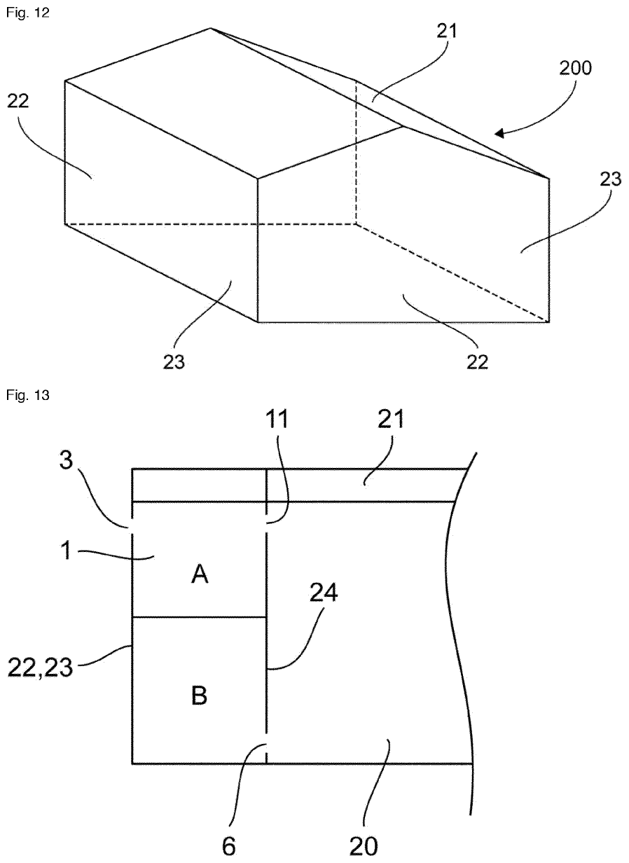

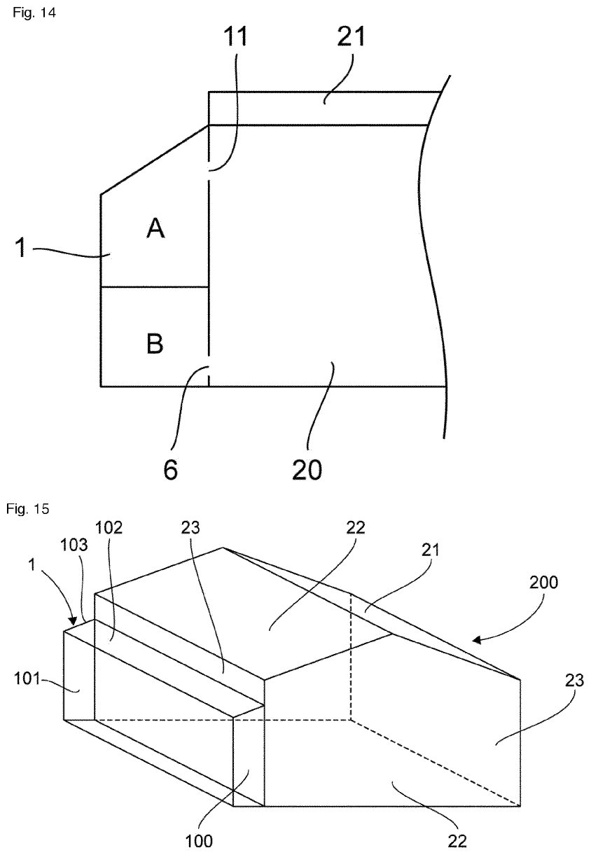

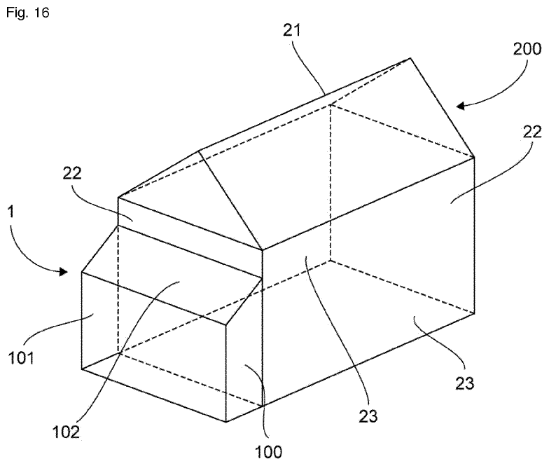

A third aspect of the invention is set forth in connection with FIGS. 10 to 16.

A first example of a cultivation greenhouse air treatment chamber according to the invention is set forth in connection with FIG. 10.

As is represented, such a treatment chamber 1 forms an enclosure.

This treatment chamber comprises an upper zone A.

This upper zone A comprises at least one inlet for recycling air 11 able to cooperate with a cultivation zone 20 of a greenhouse. It also comprises at least one fresh air inlet 3 able to cooperate with outside of the greenhouse.

The chamber also comprises a lower zone B.

This lower zone B comprises at least one air outlet 6 for being connected to at least one ventilation pipe 8 having a perforated peripheral wall provided to extend into the cultivation zone. It will generally comprise several air outlets 6, each of which being connected to a separate ventilation pipe.

The link between each pipe 8 and the corresponding outlet 6 is made by means of a simple connector 13 of the collar, ferrule or other type, but no longer requires the implementation of a more cumbersome, more complex and more expensive cone. This reduces the distance D between the gutter 14 and the beginning of the pipe.

At least one air passage 13 is provided between the upper zone A and the lower zone B. This passage is provided through a partition wall 9 separating the upper A and the lower B zones. The chamber comprises at least one fan 5 disposed between the upper A and lower B zones. This fan 5 is configured to induce passage of the air contained in said upper zone into said lower zone through the passage 13.

In this embodiment, the fan 5 comprises a rotor 50 the axis of rotation of which is substantially vertical. However, in alternatives, the axis of the rotor could extend in a tilted manner or essentially horizontally. In the latter case, the upper chamber A could partly extend laterally along the lower chamber B to the ground 7.

The number of fans could be equal to the number of air outlets and thus the number of ventilation pipes. However, preferentially, the number of fans could be less than the number of air outlets and thus the number of ventilation pipes. More generally, the number of fans can be uncorrelated to the number of pipes. This could allow optimisation of the characteristics of the fans.

The chamber comprises at least one flap 12 for sealing the inlet for recycling air 11. A single flap could be used to seal one or more air inlets. However, there could be as many flaps as there are air inlets.

The chamber comprises at least one flap 4 for sealing the fresh air inlet 3. A single flap could be used to seal one or more air inlets. However, there may be as many flaps as there are air inlets. In this embodiment, the flap 12 is swinging while the flap 4 is sliding (guillotine type).

More generally, the flaps 12, 4 for sealing the inlet for recycling air and the fresh air inlet are of the swinging type or of the sliding type, wherein the flaps for sealing the inlet for recycling air and the fresh air inlet could be of identical or different types.

The chamber comprises recycling air heating means 10 housed in the upper zone A. This may, for example, be an air heater or any other adapted heating means.

The chamber comprises fresh air cooling means 2 housed in the lower zone B. This may, for example, be one or more air/water exchangers, in particular cardboard panels through which fresh air circulates and inside which cold water is circulated.

A second example of a greenhouse air treatment chamber according to the invention is set forth in connection with FIG. 11.

This differs from that according to the first example in that in the first example, the renewal air inlet(s) is (are) provided in a lateral wall of the upper zone, whereas in the second example it (they) is (are) provided in an upper wall of the upper zone.

A treatment chamber according to either of these two exemplary embodiments may be implemented within different types of cultivation greenhouse.

A cultivation greenhouse 200 conventionally comprises four peripheral walls and is covered with a roof 21 generally made of glass or plastic film. The roof represented has tilted sides. However, it could be arched, gothic vaulted or otherwise. The four peripheral walls comprise two gables 22 and two front walls 23.

The treatment chamber 1 may be provided inside the greenhouse 200 between at least one peripheral wall 22, 23 of the greenhouse and an inner partition wall 24 separating the cultivation zone 20 from the air treatment chamber 1. The air inlet(s) 11 and air outlet(s) 6 are then provided through the partition wall 24 while the air inlet(s) 3 are provided through a peripheral wall 22, 23. The chamber 1 preferably extends between three peripheral walls and the inner partition wall. However, it may be segmented so that the greenhouse contains several juxtaposed chambers that are butt-joined or spaced apart from each other.

The chamber(s) may extend from the ground to the roof or stop before the roof. In the latter case, the upper part of zone A can be closed by a wall (see FIG. 10) or by a flap (see FIG. 11).

The treatment chamber 1 may also be provided outside the greenhouse 200 between a peripheral wall 22, 23 of the greenhouse and outer partition walls 100, 101, 102, 103 separating the air treatment chamber from outside.

The chamber 1 preferably extends along the entire length or width of the greenhouse. However, it may be shorter or it may be segmented into several juxtaposed chambers that are either butt-joined or spaced apart from each other.

The height H of the upper zone A could preferably be between 1.5 and 4 metres. Its width L may preferably be between 0.90 and 2 metres.

The height h of the lower zone B may preferably be between 1.8 and 3 metres. Its width I may preferably be between 0.90 and 2 metres.

Under some aspects, the present invention relates to an air treatment chamber for a cultivation greenhouse separated into two distinct volumes, the upper, first stage mainly dedicated to the management of air flows, control of flow rate, temperature and hygrometry, the lower, second stage is essentially dedicated to pressurising this treated air, mainly statically, by reducing turbulence, in order to supply the diffusion pipes with air able to exit therefrom almost perpendicular at an angle alpha of between 75° and 90°, in order to avoid non-homogeneous distribution of the air thus treated in the greenhouse, along the crops. These two stages are separated by a wall equipped with a number of fans which could be optimised to achieve this aim. Motor means for moving the sealing flaps and regulation means are conventionally implemented to control opening/closing of the various flaps and to control the implementation of the cooling means and the heating means to generate the desired atmosphere. Such regulation means are known per se and are not herein described in detail.

1. An air treatment chamber for a cultivation greenhouse, comprising:
at least one inlet for recycling air, delivering air from at least one cultivation zone of said greenhouse;
at least one fresh air inlet, delivering air from outside said greenhouse, wherein said at least one fresh air inlet is formed in a lower part of said chamber; and
at least one air outlet for feeding said at least one cultivation zone; and an upper part of said chamber,
which extends above said at least one fresh air inlet, and is equipped with elements for passing light to an interior of said greenhouse.

2. The air treatment chamber according to claim 1, comprising a seal, which seals said fresh air inlet and which can assume at least three positions:
a closed position, in which said at least one fresh air inlet is completely sealed;
at least one first open position, in which an upper part of said at least one fresh air inlet is open, for passing air therethrough; and
at least one second open position, in which a lower part of said at least one fresh air inlet is open, for passing air therethrough.

3. The air treatment chamber according to claim 2, wherein the seal can assume at least two first open positions and/or at least two second open positions, so as to modulate amount of air from outside.

4. The air treatment chamber according to claim 2, wherein the seal comprises a flap sliding in parallel to said at least one fresh air inlet, movable so as to be able to assume said closed position and said first and second open positions.

5. The air treatment chamber according to claim 2, further comprising an air heater, mounted in front of said at least one air inlet so that:
in at least one of the at least one first open position, fresh air circulates inside said air heater; and
in at least one of the at least one second open position, fresh air is not treated by said air heater.

6. The air treatment chamber according to claim 1, further comprising at least one recycling air conduit, connecting the upper part of said greenhouse to said at least one inlet for recycling air, the latter being placed in close proximity to the upper part of said at least one fresh air inlet.

7. The air treatment chamber according to claim 4, further comprising at least one recycling air conduit, connecting the upper part of said greenhouse to said at least one inlet for recycling air, the latter being placed in close proximity to the upper part of said at least one fresh air inlet; and
said at least one inlet for recycling air is placed so that said flap seals said at least one inlet for recycling air in at least one of said second open positions.

8. The air treatment chamber according to claim 1, wherein the at least one fresh air inlet comprises at least a first and a second fresh air inlets, the first fresh air inlet being equipped with cooling and/or dehumidification element, and the second fresh air inlet being placed so that fresh air circulates into a heater.

9. The air treatment chamber according to claim 4, wherein the at least one fresh air inlet comprises at least a first fresh air inlet and a second fresh air inlet, the first fresh air inlet being equipped with cooling and/or dehumidification element, and the second fresh air inlet being placed so that fresh air circulates into a heater, and wherein said flap seals both the first and second fresh air inlets or selectively releases one of said first fresh air inlet or said second fresh air inlet.

10. A cultivation greenhouse comprising:
at least one cultivation zone; and
at least one air treatment chamber, comprising:
at least one inlet for recycling air, delivering air from the at least one cultivation zone of said greenhouse;
at least one fresh air inlet, delivering air from outside said greenhouse, wherein said at least one fresh air inlet is formed in a lower part of said chamber; and
at least one air outlet for feeding said at least one cultivation zone; and
an upper part of said chamber, which extends above said at least one fresh air inlet and is equipped with elements for passing light to an interior of said greenhouse.

11. The cultivation greenhouse according to claim 10, wherein said at least one air treatment chamber is provided inside said greenhouse between at least one peripheral wall of said greenhouse and an inner partition wall separating said at least one cultivation zone from said at least one air treatment chamber.

12. The cultivation greenhouse according to claim 10, wherein said at least one air treatment chamber is provided outside said greenhouse between a peripheral wall of said greenhouse and outer partition walls separating said at least one air treatment chamber from outside.

13-38. (canceled)
